(19) United States
(12) Patent Application Publication
(10) Pub. No.: US 2016/0107927 A1
(43) Pub. Date: Apr. 21, 2016

(54) DECORATIVE GLASS AND METHOD FOR MANUFACTURING THE SAME

(71) Applicant: SEUNG BEOM NO, Bucheon-si (KR)

(72) Inventor: SEUNG BEOM NO, Bucheon-si (KR)

(21) Appl. No.: 14/863,066

(22) Filed: Sep. 23, 2015

(30) Foreign Application Priority Data
Oct. 20, 2014 (KR) 10-2014-0141853

(51) Int. Cl. C03C 17/00; C03C 17/34

(52) U.S. Cl. CPC C03C 17/007; C03C 17/34; C03C 2217/72

(57) ABSTRACT

The present invention relates to a method for manufacturing decorative glass which comprises the steps of: preparing a glass; coating a water-based pigment on one surface of the prepared glass; covering the glass in which the water-based pigment has been coated with a vinyl or a wrap, forming a pattern on the vinyl or wrap covering the glass; removing the vinyl or wrap in which the pattern has been formed; and drying the glass in which the vinyl or wrap has been removed.

The decorative glass according to the present invention has advantages in that a variety of colors and patterns rather than an uniform pattern can be expressed, a printed components based on the form of design is not required, its production costs are low, waste glass can be recycled and resources can be conserved. In addition, the decorative glass according to the present invention has advantages in that light can penetrate, and its color and pattern are beautiful, thereby implementing an aesthetic effect and an artistic value to the spaces inside or outside of buildings to which the glass is applied.

### CROSS-REFERENCE TO RELATED APPLICATIONS

This application claims the benefit of Korean Patent Application No. 10-2014-0141853, filed Oct. 20, 2014, which is hereby incorporated by reference herein in its entirety.

### BACKGROUND

1. Technical Field

The present invention relates to decorative glass and a method for manufacturing the same. More specifically, the present invention relates to a method for forming a design having various colors and shapes on the surface of the room and exterior materials made of glass materials.

2. Description of the Related Art

In general, in order to prevent damage such as scratches on the surface of objects while also exhibiting decorative effects, decorative glass is attached to furnitures, building structures, home electronic appliances and the like which are widely used in homes or business offices. Also, various types of decorative glass are used as ornaments or as furnishings within the interior or exterior of rooms.

This decorative glass is usually formed so as to express a variety of colors and patterns or shapes, by either surface-etching or by forming a plurality of printed layers on the back surface of a glass plate through heat treatment.

As decorative glass from among the above-described conventional decorative glass, “Decorative glass for refrigerator and method for manufacturing thereof” has been proposed in Korean unexamined patent publication no. 10-2009-0105254, and “Decorative glass and method for manufacturing thereof” has been proposed in Korean unexamined patent publication no. 10-2009-0021022. The methods of these publications comprise forming a printed layer which provides a single layer or a multi-layer on one surface of the glass plate and attaching a protective film layer on the top surface of the printed layer. However, they have disadvantages in that colors and patterns or shapes are produced equally or uniformly. Therefore, in order to solve this problem, printed components for representing various colors and patterns or shapes are necessary and a lot of general expenses are involved.

Furthermore, in order to produce decorative glass which can exhibit natural and antique aesthetics, a method for manufacturing decorative glass using a natural-patterned wood or a Korean handmade paper has been suggested.

Conventionally, as the method for using a natural-patterned wood, “Process for forming natural wood carved ornaments” has been suggested in Korean unexamined patent publication no. 10-1999-0031895. This process comprises carving a natural-patterned wood to which a reinforcing paper is attached in various shapes, adhering it to various kinds of glass by using an adhesive such as an emulsion adhesive and then forming a urethane layer on the surface thereof. Such decorative glass can give comfort through natural beauty that appears in a natural-patterned wood, but the processes of making natural wood carved ornaments by cutting a natural-patterned wood into various shapes to meet the prepared design and adhering the cut pieces to a tape is very difficult, and the difference of aesthetics expressed based on the form of designs is high and so it is not easy to express the proper sense of luxury.

On the other hand, in the method using the Korean handmade paper, attempts have been made to attach the Korean paper an the back surface of the glass or to display a pattern onto the Korean paper. The decorative glass to which the Korean paper is attached has disadvantages in that the Korean paper is decolorized or discolored during its use and so it is not maintained in a good condition for a long period of time.

In addition, these types of conventional decorative glass have disadvantages in that they can be applied only to a plate type of glass and so they cannot be applied to the accessories of glass materials rather than the plate glass.

### PRIOR ART DOCUMENT

### Patent Document

(Patent Document 1) KR 10-2009-0105254 A

(Patent Document 2) KR 10-2009-0021022 A

(Patent Document 3) KR 10-1999-0031895 A

### SUMMARY

The present invention has been made keeping in mind the above problems encountered in the prior arts, and an object of the present invention is to provide decorative glass in which a pattern is formed on the glass using a water-based pigment and light can penetrate to endow a beautiful color and pattern, which can be used for interior decoration or as a glass tile

Also, another object of the present invention is to provide decorative glass that is capable of expressing a variety of colors and patterns rather than a consistent pattern, even without use of a separate printed component thereby achieving an aesthetic effect and implementing an artistic value to the spaces to which glass is applied, both inside and outside of the building.

In addition, a further object of the present invention is to provide a method for manufacturing decorative glass which can be applied to various glass artistic products rather than a plate glass and for recycling waste glass and conserving resources, because the present method is not a method using printing.

In order to accomplish the above objects, the present invention provides a method for manufacturing decorative glass which comprises the steps of:
preparing a glass;
coating a water-based pigment on one surface of the prepared glass;
covering the glass in which the water-based pigment has been coated with a vinyl or a wrap;
forming a pattern on the vinyl or wrap covering the glass;
removing the vinyl or wrap in which the pattern has been formed; and
drying the glass in which the vinyl or wrap has been removed.

The method of the present invention is characterized in that the step of coating a water-based pigment on one surface of the glass comprises the steps of: coating a colored water-based pigment except a black on one surface of the glass; and coating a black water-based pigment on the coated colored water-based pigment.

The method of the present invention is characterized in that, after the step of drying the glass in which the vinyl or wrap has been removed, a step of coating a ground color water-based pigment on the dried glass is further included.

The method of the present invention is characterized in that, after the step of coating a colored water-based pigment except black on one surface of the glass, a step of coating a pearl particle to the water-based pigment is further included and, after the step of dying the glass in which the vinyl or wrap has been removed, a step of coating a transparent paint on one surface or both surfaces of the dried glass is further included.

The decorative glass according to the present invention comprises a glass; a colored water-based pigment except black which is coated on one surface of the glass; and a black water-based pigment which is applied to the colored water-based pigment, wherein a part of the black water-based pigment is removed and the colored water-based pigment on the inside is exposed to the outside to thereby form a pattern.

The decorative glass according to the present invention has advantages in that a variety of colors and patterns rather than a consistent pattern can be expressed, a printed component based on the form of design is not required, its production cost is low, waste glass can be recycled and resources can be conserved.

In addition, the decorative glass according to the present invention has advantages in that light can penetrate and its color and pattern are beautiful, thereby implementing an aesthetic effect and an artistic value to the spaces inside or outside of buildings to which glass is applied.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating the manufacturing process of the decorative glass according to the present invention.

FIG. 2 is a view illustrating the waste glass according to the present invention.

FIG. 3 is a view illustrating that a colored water-based paint, other than a black paint, is coated on the waste glass according to the present invention

FIG. 4 is a view illustrating that a pearl particle is coated to FIG. 3.

FIG. 5 is a view illustrating that a black water-based pigment is coated to FIG. 4.

FIG. 6 is a view illustrating that a pigment is covered by a wrap in FIG. 5.

FIG. 7 is a view illustrating that a wrap is removed in FIG. 8.

FIG. 8 is a view illustrating that a silver water-based pigment is coated as a ground color water-based pigment to FIG. 7.

FIG. 9 is a view illustrating that a green water-based pigment is coated as the ground color water-based pigment to FIG. 8.

FIG. 10 is a photograph in which the coating of FIG. 9 is dried and then turned over.

FIG. 11 through FIG. 14 show the decorative glasses having a variety of patterns according to the present invention.

### DETAILED DESCRIPTION

Hereinafter, the present invention will be described in more detail with reference to the accompanying drawings, throughout which the same reference numerals are used to designate the same or similar components.

Conventional decorative glass was used after printing a designed pattern on the glass using a printing device. However, as their color and pattern were limited, the interior effect was not good and so the overall decoration effect was not excellent.

Moreover, in order to achieve various aesthetic senses, the decorative glass was prepared using a patterned wood or a Korean handmade paper. However, they have disadvantages in that the manufacturing costs increase more than necessary and also the durability is not good and thereby they cannot be applied in various fields.

Accordingly, in order to solve the several problems encountered with the conventional decorative glass, the decorative glass of the present invention is designed so that various patterns can be formed directly on the glass without printing a designed pattern, thereby achieving aesthetic sense and also no requiring the separate printing of parts or materials, thereby lowering the manufacturing costs. Moreover, a glass, other than a plate type, can be used and waste glass can be recycled, thereby allowing the decorative glass of the present invention to be applied in various fields.

The method for manufacturing decorative glass according to the present invention is characterized in that the method comprises the steps of: preparing a glass; coating a water-based pigment on one surface of the prepared glass; covering the glass in which the water-based pigment has been coated with a vinyl or a wrap; forming a pattern on the vinyl or wrap covering the glass; removing the vinyl or wrap in which the pattern has been formed; and drying the glass in which the vinyl or wrap has been removed.

According to the present invention, when the decorative glass is used in a state where the other surface of the glass, and not the surface on which the water-based pigment is coated, is exposed to the outside, a more beautiful appearance can be provided, but it is not necessarily limited thereto.

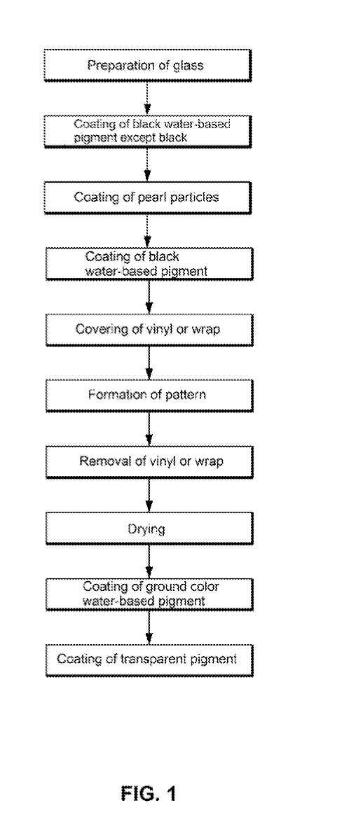

Hereinafter, the present invention will be described in detail by manufacturing steps with reference to FIG. 1.

Step of Preparing Glass

First, glass is prepared to manufacture the decorative glass. In this case, the glass may be a plate glass or it may be other various types of glass other than a plate glass and its shape is not limited. That is, since the present invention is not a method of printing the plate glass using a printing device, its shape does not necessarily need to be that of a flat plate and so it can be applied to a variety of glass art products.

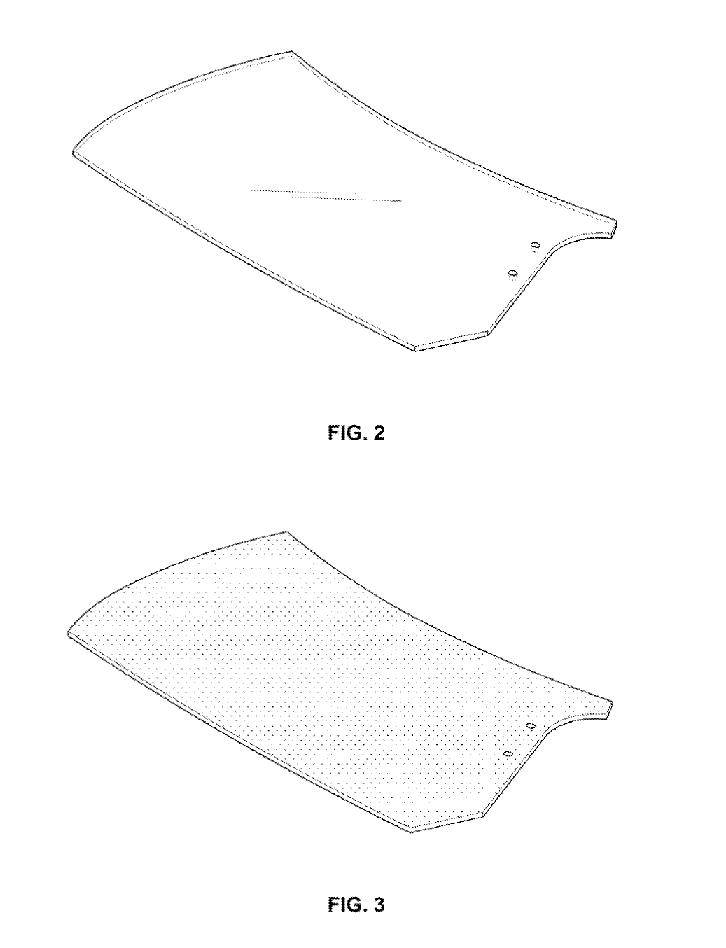

In addition, since waste glass, and not new glass, can be used, when using waste materials such as glass for automobile windows or glass for building windows, the ability to recycle resources is excellent and also the manufacturing costs can be significantly reduced. The attached FIG. 2 is a view illustrating that glass for automobile window which is recyclable has been prepared.

Step of Coating a Water-Based Pigment on One Surface of the Prepared Glass

Next, the water-based pigment is coated on one surface of the prepared glass. In this case, although the pattern may be formed after coating only one color of the water-based pigment, in order to obtain a more beautiful and preferable pattern it is preferable to coat the water-based pigment through the following steps.

Firstly, a colored water-based pigment except black is coated on one surface of the prepared glass and then air-dried for about 1 to 10 minutes. Next, secondarily, a black water-based pigment is coated on the dried colored water-based pigment. Here, the colored water-based pigment does not need to be completely dried, and to improve the efficiency it is also possible to coat the black water-based pigment in a semi-dry state.

That is, subsequently, when forming a pattern by using a black water-based pigment, the black water-based pigment is partially removed and the colored water-based pigment on the inside is exposed. The not-removed water-based pigment on the black side exposes black as it stands thereby forming a beautiful pattern.

According to the present invention, the black water-based pigment is coated and then removed. The reason is because, in the case of the black water-based pigment, if the black water-based pigment is not removed, ultimately the color of the colored water-based pigment on the inside is not visible on the other surface of the glass and only the black water-based pigment is displayed, thereby allowing manufacturing of the decorative glass having an overall clean color.

In this case, if exposure of a separate color is not desired, only the black water-based pigment alone can be used, and only a colored water-based pigment other than black can be used to form a pattern, However, in order to obtain the desired aesthetic effect, it is preferable that a colored water-based pigment other than black is coated and then the black water-based pigment is coated.

In addition, since the present invention uses a water-based pigment, in the case of the colored water-based pigment except black, the light permeation is excellent. Although two or more water-based pigments are coated, the water-based pigment on the inside permeates to the outside and a desired visual sense can be achieved. Therefore, it is natural that one colored water-based pigment can be used and then dried and that next the colored water-based pigment having another color can be used and then dried.

As the water-based pigment, a variety of pigments that are conventionally available can be used. Since it is a water-based pigment, it is diluted with water to match a desired color. Further, if a color is too dark upon using the colored water-based pigment, the light permeation is reduced. When used as decorative glass, the aesthetic effect can be lowered. Therefore it is preferred that the water-based pigment and water are diluted and used at a weight ratio of 1:3-10.

The water-based pigment can be coated by using an air brush or a brush, but its method is not limited and the amount used is not limited. It is enough to coat the water-based pigment to mate the color to the extent that the coated pigments do not flow down the glass.

Meanwhile, in order to manufacture a more beautiful decorative glass, a step of coating a colored water-based pigment other than black and then coating pearl (gutter) particles on the whole or part of the water-based pigment before drying the colored water-based pigment can be further included. Here, the coating refers to spraying pearl particles with an air brush and the like, and the amount used is also not limited. The kind of pearl particle is not limited as long as the particles can also have glitter, Here, pearl particles are already well known in the pigment field and so the detailed description thereof will be omitted.

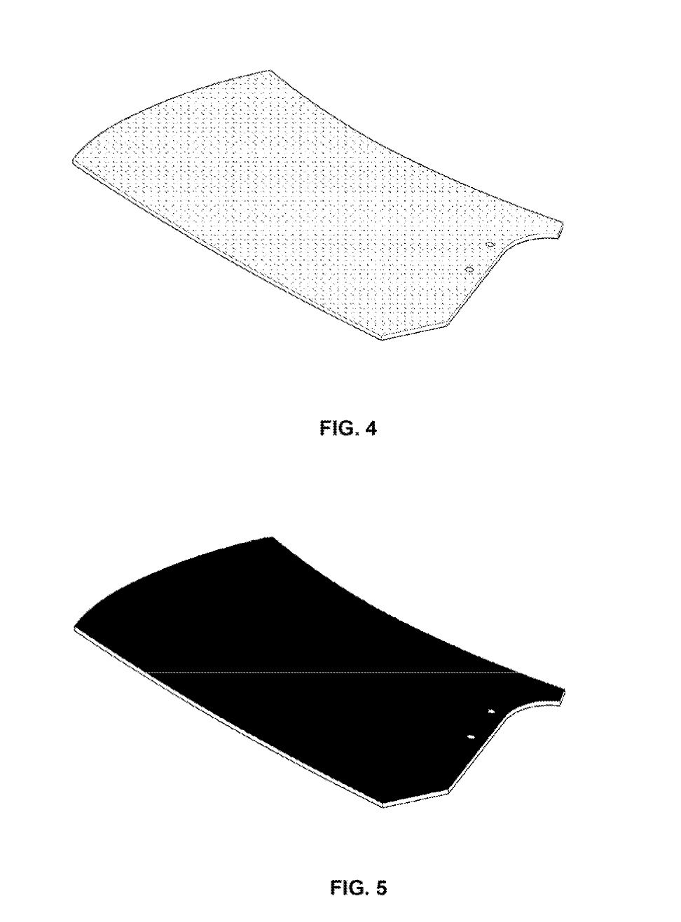

FIG. 3 is a view illustrating that the green water-based pigment is coated. FIG. 4 is a view illustrating that a pearl particle is sprayed, and FIG. 5 is a view illustrating that a black water-based pigment is coated.

Step of Covering the Glass in which the Water-Based Pigment has been Coated with a Vinyl or a Wrap

Next, when coating of the water-based pigment has been completed, that is, when coating of up to the black water-based pigment has been completed, the black water-based pigment is covered with a vinyl or wrap before the black water-based pigment is dried. Here, the pigment must be covered with a vinyl or a wrap immediately after the black water-based pigment is coated. This is because when the black water-based pigment is dried, the black pigment does not adhere to the vinyl or wrap and removal of the black water-based pigment is difficult and thereby a pattern cannot be formed.

Step of Forming a Pattern on the Vinyl or Wrap Covering the Glass

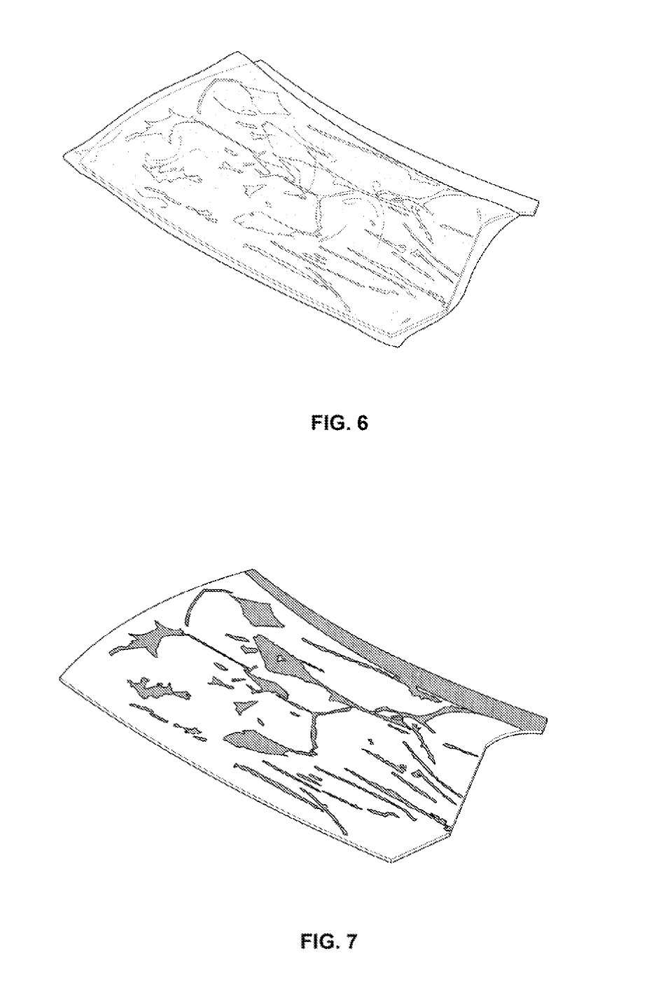

A pattern is formed on a vinyl or a wrap by using an air brush, or a pattern is formed on the vinyl by using a brush, a bar or a palm. That is, when applying an air by using the air brush, the not dried black water-based pigment is adhered to the vinyl or wrap, the water-based pigment is pushed to the left and right sides and thereby a part of the colored water-based pigment on the inside is exposed. These operations use most conveniently an air brush, but the methods thereof are not limited. These are available if the black water-based pigment is adhered to the vinyl or wrap and partially removed, and further pushed in all directions and the colored water-based pigment on the inside can be exposed. FIG. 6 is a view illustrating that a pattern is formed by using an air brush after covering with the vinyl or wrap.

Step of Removing the Vinyl or Wrap in which the Pattern has been Formed

After forming a pattern, the vinyl or wrap is removed. When the vinyl or wrap is removed, a state where a part of the black water-based pigment is removed can be confirmed. It can also be confirmed that the green water-based pigment on the inside is exposed to the outside.

Step of Drying the Glass in which the Vinyl or Wrap has been Removed

Next, the glass in which the vinyl or wrap has been removed is dried, It is enough for the glass to be air-dried and the drying is sufficiently conducted within about 5 to 10 minutes. Therefore, there is no need to provide separate heating means or blowing means.

Step of Coating a Ground Color Water-Based Pigment on the Dried Glass

When the drying is completed, the glass after completion of the manufacturing process is turned over, that is, the side on which the water-based pigment is not coated is used such that it is on the inside. In order to manufacture a more beautiful decorative glass, a ground color water-based pigment can be coated on the dried glass after the drying. In this case, when silver is used as the ground color, the effects of permeating or glittering the light are typically excellent. This is not necessarily limited thereto.

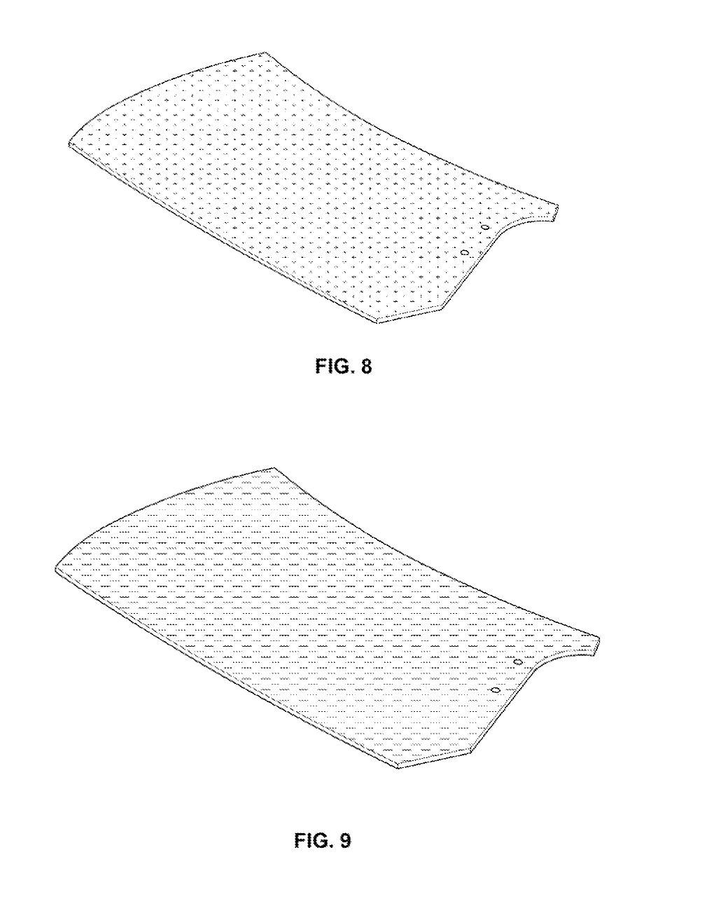

In addition, in order to obtain a more beautiful appearance, firstly the silver ground color water-based pigment is coated as shown in FIG. 8 and then secondarily the colored water-based pigment, that is, the colored water-based pigment initially coated on the previously prepared glass, can be further coated. In this case, unity is imparted to the overall color, a beautiful color and glittering effect appear during permeation of light and thereby the overall visual effect is excellent.

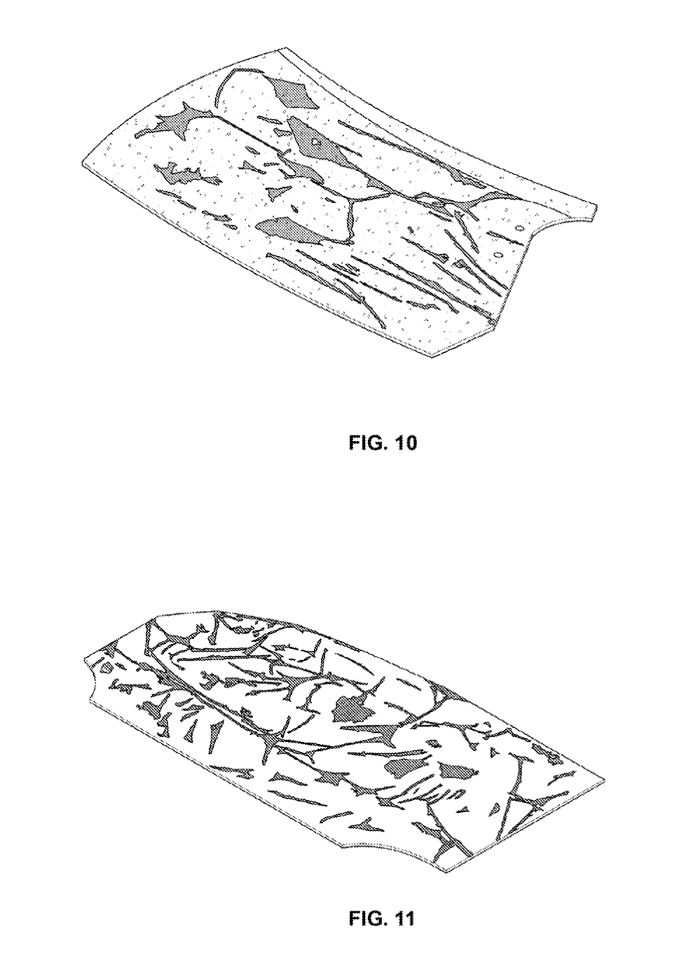

Further, when the ground color water-based pigment is coated, it is air-dried for 5 to 10 minutes. FIG. 10 is a view illustrating that the water-based pigment is dried and the side in which the water-based pigment is not coated is turned over so as to be toward the upper surface.

Moreover, if use of both sides of the decorative glass is desired, a pattern can also be imparted on the glass through a ground color water-based pigment, and a pearl particle can be further coated on the ground color water-based pigment. The invention is not limited to this embodiment.

Then, prior to coating the ground color water-based pigment, a heat-sensitive pigment is coated and then a ground color water-based pigment can be further coated. The heat-sensitive pigment uses a reversible heat-sensitive pigment in which the color begins to be eliminated as it reaches a specific temperature, and it becomes transparent when it reaches the specific temperature, and then it goes back to the original color when the temperature is lowered. Various types of reversible heat-sensitive pigments, commercially available, can be used. Here, the specific temperature is about 30° C. Depending on the internal and external temperatures, a heat-sensitive pigment or a ground color water-based pigment is exposed to the outside. After coating the heat-sensitive pigment, the ground color water-based pigment is coated in a state wherein the ground color water-based pigment is dried. When using a ground color water-based pigment having two or more colors, it is preferred that the coated primary ground color water-based pigment is dried and then further coated.

Step of Coating a Transparent Paint on One Surface or Both Surfaces of the Dried Glass

Next, a transparent paint is coated on one surface of the ultimately dried glass, that is, on the side on which the water-based pigment is coated, so that the water-based pigment can be protected. At this time, the kind of the transparent paints is not limited, but it is preferable to use a transparent paint intended for an automobile, rather than the water-based paint used previously. In this case, the water-based pigment and glass are protected from external scratching and impact and also a gloss is imparted to thereby make the decorative glass more beautiful.

Further, a transparent paint is coated even on the other side of the dried glass to further impart a gloss and also improve its strength.

In other words, since the decorative glass manufactured through the manufacturing process does not use the printing device as previously described, a plate glass is not required. Although the shape of the glass is not a flat plate, the pattern can be sufficiently formed by using an air brush.

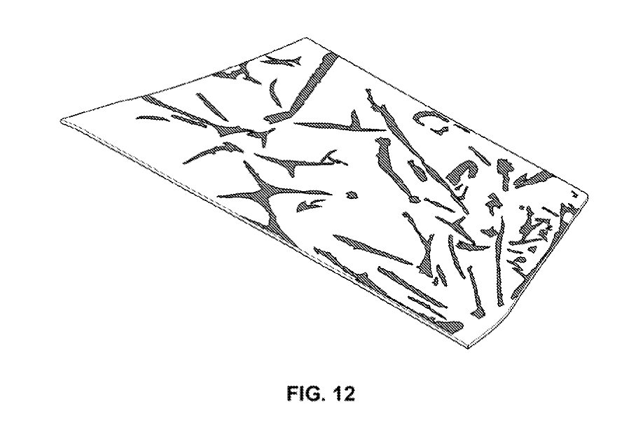

Further, as shown in FIG. 10 as wall as in FIG. 11 and FIG. 12, the decorative glass of the present invention can be variously used for interior decoration and glass tiles because the decorative glass patterns are not all constant or uniform, but the appearance is beautiful, light is permeated and decorative effects are excellent, and the color is excellent. Moreover, the manufacturing costs are also cheaper and so they will be price-competitive when used as glass tiles.

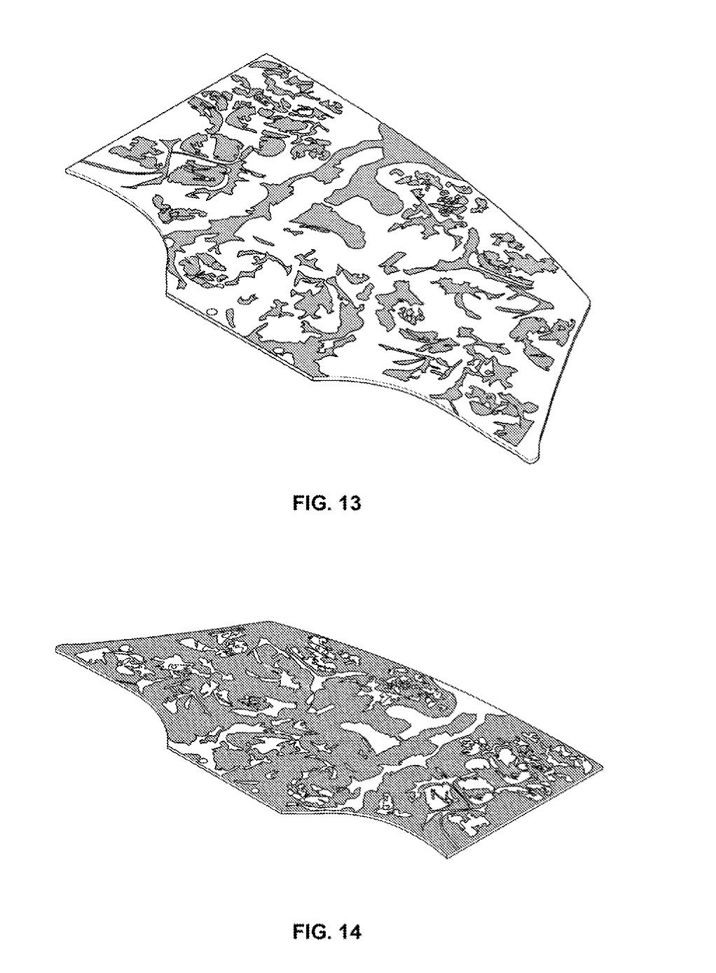

Meanwhile, in the above, it has been described that the coating operation of the water-based paints is performed only on one side of the glass, but as shown in FIG. 13 and FIG. 14, the coating operation of the colored water-based paint and the black water-based paint can be performed on both sides. Their various coating operations are not limited and the pattern can be formed on one side or both sides of the glass.

That is, the decorative glass of the present invention comprises an underlying glass, a colored water-based pigment coated on one side of the glass, and a black water-based pigment coated on the colored water-based pigment. The back water-based pigment is partially removed and the colored water-based pigment on the inside is exposed to the outside, thereby forming a pattern. In this process, various patterns, color, and light permeability are imparted. Therefore, as compared with the decorative glass in which conventional printing layers are formed, the appearance is more beautiful and the manufacturing costs are low, and it is possible to secure a price competitiveness.

In the above, the present invention has been described using the preferred embodiments, but the scope of the present invention is not limited to the specifcial embodiments and must be interpreted by the appended claims. Also, it will be appreciated to those skilled in the art that various modifications, additions and substitutions can be made to the invention without departing from the scope and spirit of the invention.

What is claimed is:

1. A method for manufacturing decorative glass which comprises the steps of preparing a glass;
coating a water-based pigment on one surface of the prepared glass;
covering the glass in which the water-based pigment has been coated with a vinyl or a wrap
forming a pattern on the vinyl or wrap covering the glass;
removing the vinyl or wrap in which the pattern is formed; and
drying the glass in which the vinyl or wrap is removed.

2. The method for manufacturing decorative glass of claim 1 wherein the step of coating a water-based pigment on one surface of the glass comprises the steps of: coating a colored water-based pigment except black on one surface of the glass; and coating a back water-based pigment on the coated colored water-based pigment.

3. The method for manufacturing decorative glass of claim 1 wherein, after the step of drying the glass in which the vinyl or wrap has been removed, a step of coating a ground color water-based pigment on the dried glass is further included.

4. The method for manufacturing decorative glass of claim 1 wherein, after the step of coating a colored water-based pigment except black on one surface of the glass, a step of coating pearl particles on the water-based pigment is further included and, after the step of drying the glass in which the vinyl or wrap has been removed, a step of coating a transparent paint on one surface or both surfaces of the dried glass is further included.

5. Decorative glass which comprises a glass; a colored water-based pigment except black which is coated one surface of the glass; and a black water-based pigment which is applied to the colored water-based pigment, wherein a part of the black water-based pigment is removed and the colored water-based pigment on the inside is exposed to the outside to thereby form a pattern.
